(19) United States
(12) Patent Application Publication
(10) Pub. No.: US 2007/0044151 A1
(43) Pub. Date: Feb. 22, 2007

(54) SYSTEM INTEGRITY MANAGER

(75) Inventor: James J. Whitmore, Carlisle, PA (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 11/161,905

(22) Filed: Aug. 22, 2005

(51) Int. Cl. G06F 12/14

(52) U.S. Cl. 726/23

(57) ABSTRACT

A system integrity manager, system, computer program product and method for providing security may include transforming an operational behavior of an instance of a computing system from a general purpose computing system to a special purpose computing system. The operational behavior may be transformed by using at least one of a system integrity sensor and a system integrity effector and a set of system integrity policies and system integrity data.

### BACKGROUND OF THE INVENTION

The present invention relates to computing environments or systems, and more particularly to a system integrity manager to provide security from attacks, threats or threat agents and other possibly harmful influences for general purpose computing systems or the like.

Computing systems or environments include computer hardware and software combinations. These systems may include single or multiple instances of operating system software, application software for specific purposes or functions, management software to manage operations or functions of the hardware and software components of the computing system or similar software. The vast majority of such systems may be characterized as “commercial, off the shelf” or “general purpose”. These systems also typically operate in a network information system and have access to other systems and networks. The security and integrity of these other systems or networks may be unknown and suspect. These “general purpose computing systems” can provide great value because of their rich functionality and commodity pricing. However, the deployment and operation of these “general purpose computing systems” often results in increased exposure to security attacks and high system, network and operational security management costs.

### BRIEF SUMMARY OF THE INVENTION

In accordance with an embodiment of the present invention, a method for providing security may include transforming an operational behavior of an instance of a computing environment or system from a general purpose computing environment or system to a special purpose computing environment or system. The operational behavior may be transformed by using one or more system integrity sensors and one or more system integrity effectors, a system integrity manager and a set of system integrity policies and system integrity data.

In accordance with another embodiment of the present invention, a system for providing security may include a system integrity manager for transforming an operational behavior of an instance of a computing system from a general purpose computing system to a special purpose environment. The system may also include at least one system integrity sensor to gather operational data related to operating conditions and operations within the computing system. The system may also include at least one system integrity effector to apply changes to configuration, operating conditions and operations within the computing system.

In accordance with another embodiment of the present invention, a system for providing security for a computing system may include a system integrity manager or the like for transforming an operational behavior of an instance of a computing system from a general purpose computing system to a special purpose computing system. The system for providing security may also include means for gathering events and measurements, means for transferring evidence of the events and measurements to the system integrity manager, and means for interpretation of the events and measurements in the context of threats and vulnerabilities. The system for providing security may also include means for establishing a plan of action by the system integrity manager based upon the evaluation of the current and projected state of the computing system in relation to business and technical policies or operational norms. The system for providing security may also include means for communicating control messages and commands to system integrity effectors or the like, and initiation of operational adjustments and commands to accomplish adaptive control of the computing system.

In accordance with another embodiment of the present invention, a computer program product for providing security may include a computer usable or computer readable medium having computer useable program code embodied therein. The computer useable medium may include computer useable program code configured to transform an operational behavior of an instance of a computing system from a general purpose computing system to a special purpose computing system.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a flow chart of an example of a method for providing security or integrity in a computing system or environment in accordance with an embodiment of the present invention.

FIG. 2 is a flow chart of an example of a method for invoking adaptive behavior in a computing system or environment in accordance with an embodiment of the present invention.

FIG. 3 is a flow chart of an example of a method for maintaining a normative operational profile of a computing system or environment in accordance with an embodiment of the present invention.

FIG. 4 is a flow chart of another example of a method for maintaining a normative operational profile of a computing system or computing environment in accordance with another embodiment of the present invention.

FIG. 5 is a flow chart of a method for defining a normative operational profile and behavior of a computing system or environment in accordance with an embodiment of the present invention.

FIGS. 6A and 6B (collectively FIG. 6) are a block schematic diagram of an exemplary system for providing security or integrity in accordance with an embodiment of the present invention.

FIG. 7 is a block diagram of an example of a system integrity manager (SIM) and a system integrity profile including system integrity policies to direct the SIM to manage system behavior in accordance with an embodiment of the present invention.

FIG. 8 is a block diagram of an example of an integrity subsystem and exemplary functions and operations of the integrity subsystem in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer useable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer useable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

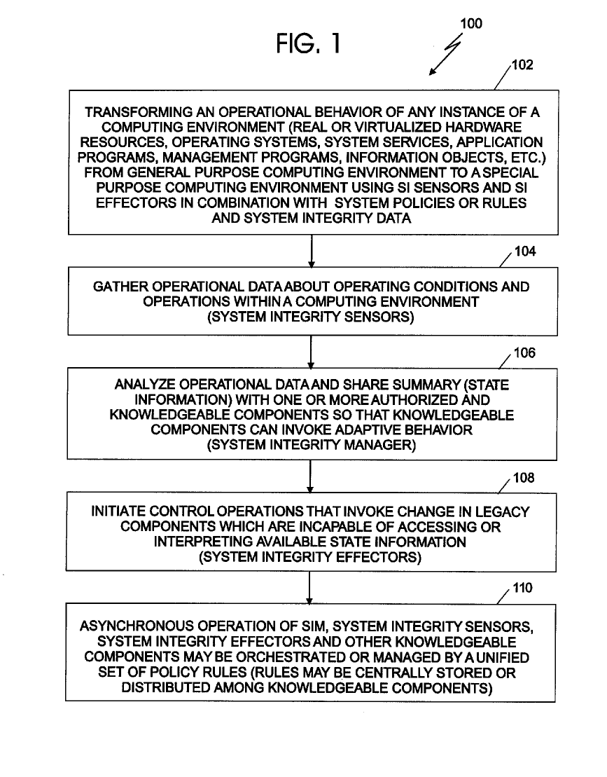

FIG. 1 is a flow chart of an example of a method 100 for providing security or integrity in a computing system or environment in accordance with an embodiment of the present invention. In block 102, an operational behavior of any instance of a computing environment or system may be transformed from a general purpose computing system to a special purpose environment. The instances of the computing system may be real or virtual hardware resources, operating systems, system services, application programs, management programs, information objects or the like. A general purpose computing environment or system may be defined as a computing environment that may perform multiple functions and operations, such as data processing, accessing a network, transmitting and receiving data, loading and executing files or programs or the like. A special purpose computing environment or system may perform the same or similar operations and may also include a system integrity profile including a detailed set of system integrity policies that explain and define a purpose or business intent of the computing system or environment. As described herein, the system integrity policies may direct a system integrity manager (SIM) to manage the computing environment or system's behavior. By managing the system's behavior, the range of security vulnerabilities that can be exploited by threats or threat agents may be reduced. Additionally, operational security management may be improved by preventing certain classes of attacks, thereby reducing uncorrelated security event information flowing on a network. More accurate and detailed security event information may also be provided to a Network Operations Center (NOC), Security Event Management Software or the like.

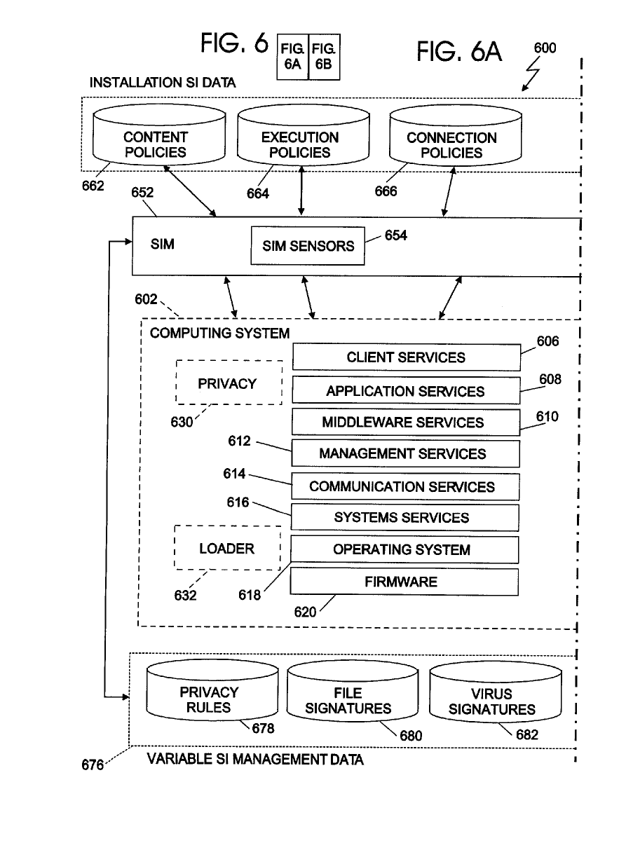

The special purpose computing system will preferably have a normative operational behavior that may be established during the solution development process or process to define the business intent or purpose of the computing system. The normative operational behavior may be defined by a set of normative operational profiles as described in more detail with reference to FIG. 5. The elements of the present invention may maintain the normative operational profiles of the computing system by causing adaptive behavior in the different components of the computing system as described in more detail herein.

In block 104, operational data about operating conditions and operations within a computing system may be gathered. The operational data may be gathered by System Integrity sensors or SIM sensors. SIM sensors may be software, virtual modules or the like that may access or communicate with different components forming a computing system or environment to gather the operational data. System integrity sensors may be software components that supply information to the System Integrity Manager. System Integrity Managers rely upon the correct and reliable operation of System Integrity sensors. System Integrity sensors may interface to hardware or software probes that use analog or digital sampling techniques to measure critical operating parameters such as the status of electrical power reserve or current drain, the status and performance of integrated and peripheral devices, such as processors, storage devices, communications adapter equipment, and the like. System integrity sensors may be firmware or software mechanisms with algorithms and queues that capture operational data from the computing system. The operational information may be generated by software, firmware or hardware and either stored in log files or transmitted as alerts. The log records and alerts may represent historical information that may be referred to as “events”. “Events” may be collected in real time, in near real time, in volume at desired intervals, or as a result of a trigger. System Integrity sensors may stimulate the system in order to measure the system's reaction to a probe or algorithm. The stimulation may involve for example, the invocation of an operator command, or, for example, the injection of an operational disturbance such as a temporary interruption of a component or service. System Integrity sensors may be fixed in function or configurable. Configurable System Integrity sensors may accept algorithms that modify their basic operation or their analytic capability. Configurable System Integrity sensors may accept parameters that modify the type, frequency, range and detail of measurements taken or historical records captured. Common examples of System Integrity sensors within computer systems include: software adapters and extensions that extract information from component log files and operating system resource tables, software components that perform input and output operations to hardware/firmware devices that are accessible through channels, devices and ports known to the computing system hardware.

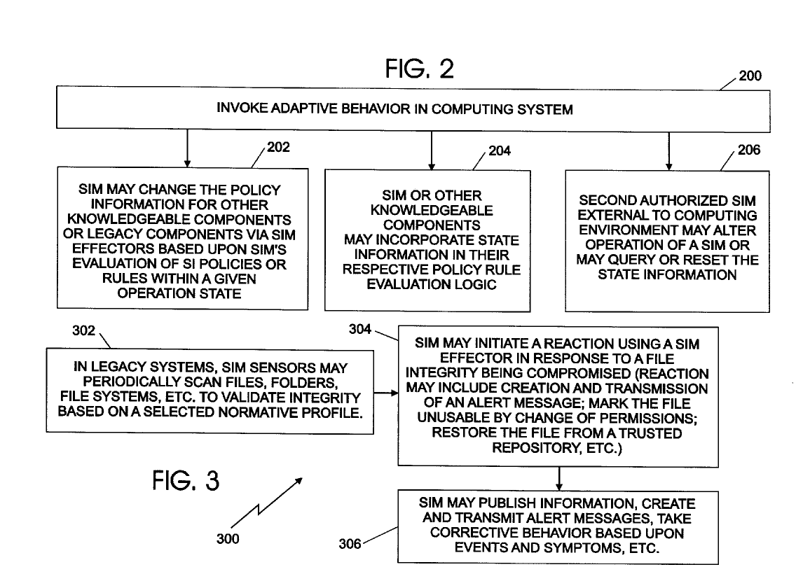

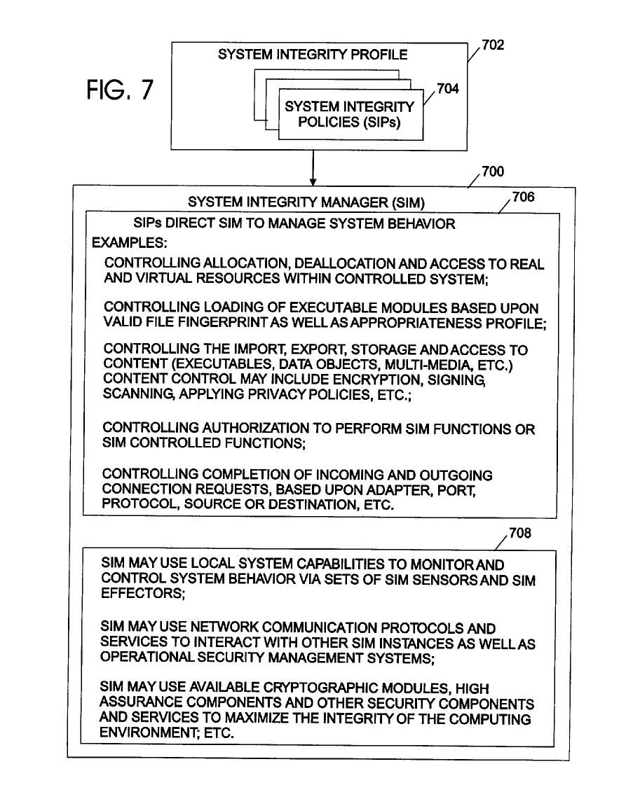

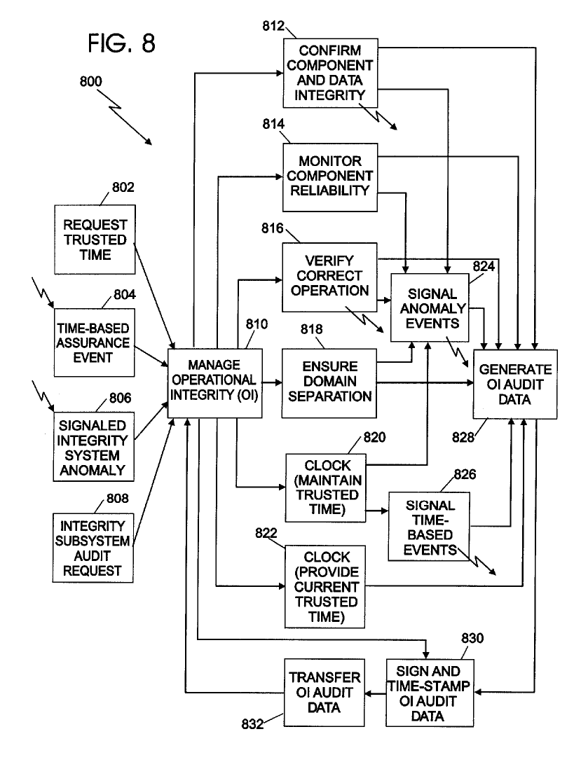

In block 106, operational data gathered by the SIM sensors may be analyzed. A summary of the analysis or state information characterizing the operational data may be formed that may be useful to components of the computing system to adapt behavior for improving system security or integrity. The summary or state information may be shared with one or more authorized and knowledgeable components of the computing system. Knowledgeable components may be defined as components that can utilize the state information to invoke adaptive behavior to improve security or integrity of the system. Examples of different ways for invoking adaptive behavior in the computing system or environment will be described with reference to FIG. 2. The analysis of the operational data and sharing the state information may be performed by the System Integrity Manager, or SIM. Operation of the SIM will be described in more detail with reference to FIGS. 7 and 8.

In block 108, control operations that invoke changes in legacy components to improve security and integrity of the computing system may be initiated and performed. Legacy components may be defined as components of a computing system that are incapable of accessing or interpreting available state information. The control operations that invoke the changes in the legacy components may be performed by system integrity effectors or SIM effectors. SIM effectors may be software, virtual modules or the like that may access or communicate with different legacy components forming a computing system or environment to cause the legacy components to alter their operational behavior to provide improved system integrity and security from attacks. System integrity effectors may be software components that invoke changes specified by the System Integrity Manager. System Integrity Managers rely upon the correct and reliable operation of System Integrity effectors. System Integrity effectors may interface to hardware mechanisms or software routines that change the behavior of all or part of the operating characteristics of the computing system. Examples of operating characteristics or operating parameters may include: electrical power current drain, the status and performance of integrated and peripheral devices, such as processors, storage devices, communications adapter equipment, and the like. System integrity effectors may be firmware or software mechanisms with algorithms and queues that modify the operational parameters of the computing system and its processes. The operational parameters are commonly found in configuration files and control tables associated with software components such as the operating system, communications software, middleware, security software, applications, etc. System Integrity effectors may invoke control or effect changes in computer system operation directly, or indirectly. Direct control may be accomplished when the System Integrity effector can invoke or respond to a control request within the resource that is controlled. An example of direct control may be an operating system command line interface for modifying operating system functions. Indirect control may be accomplished when the System Integrity effector can invoke or respond to a control request outside of the resource that is controlled. An example of indirect control may be an operating system command line interface for modifying non-operating system functions. System Integrity effectors may be fixed in function or configurable. Configurable System Integrity effectors may accept algorithms that modify their basic operation or their analytic capability. Configurable System Integrity effectors may accept parameters that modify the type, frequency, range and impact of control measures. Common examples of System Integrity effectors within computer systems may include: software adapters and extensions that invoke control interfaces within software components, operating systems, communications control software, security identify and access management software, components that perform input and output operations to hardware/firmware devices that are accessible through channels, devices and ports known to the computing system hardware, or the like.

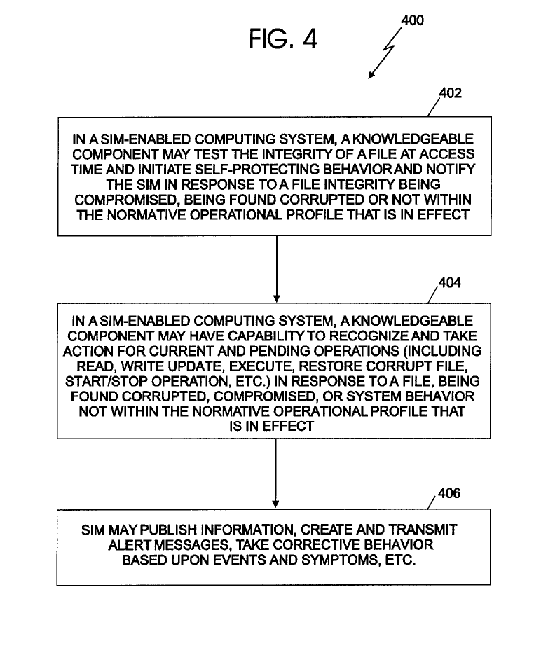

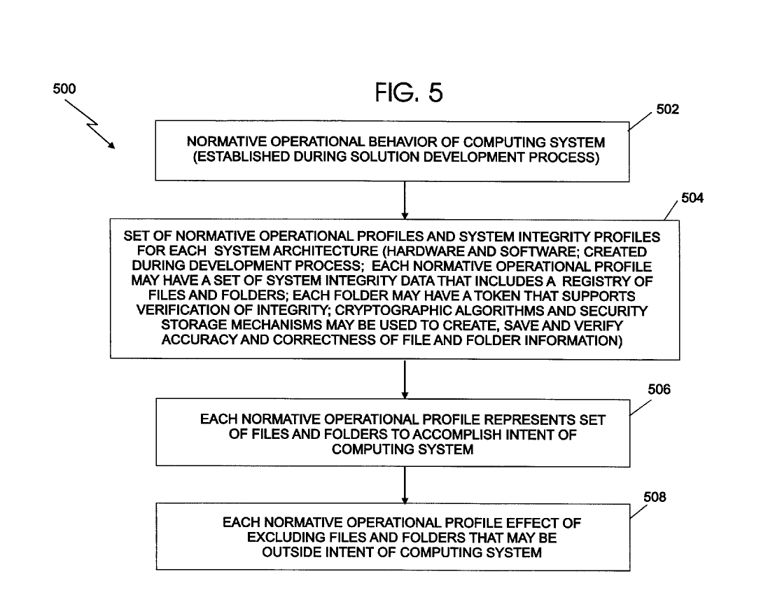

In block 110, operations of the SIM, SIM sensors, SIM effectors and other knowledgeable components may be asynchronous and may be orchestrated or managed by a unified set of policies or policy rules. The set of policies or policy rules may be established as part of the normative operational behavior of the computing system along with the normative operational profiles and system integrity profiles which may be established during the solution development process as described with reference to FIG. 5. The SIM, SIM sensors and SIM effectors may maintain the normative operational profiles of the computing system as described in more detail with reference to FIGS. 3 and 4. The rules may be centrally stored or may be distributed among the knowledgeable components.

FIG. 2 is a flow chart of an example of a method 200 for invoking adaptive behavior in a computing system or environment in accordance with an embodiment of the present invention. Examples of invoking adaptive behavior in a computing system are illustrated in the blocks 202, 204 and 206. In block 202, a SIM may change the policy information for legacy components via SIM effectors, as described above and in other knowledgeable components based upon the SIM's evaluation of the system integrity policies or rules within a given operational state of the system.

In block 204, the SIM or other knowledgeable components may incorporate state information in their respective policy rule evaluation logic to improve system security or integrity. In block 206, a second authorized SIM external to the computing system may alter operation of the SIM associated with the computing system to invoke adaptive behavior. The second external SIM may also query or reset the state information to invoke adaptive behavior in the computing system.

FIG. 3 is a flow chart of an example of a method 300 for maintaining a normative operational profile of a computing system or environment in accordance with an embodiment of the present invention. The method 300 may be applicable in a legacy computing system or environment which may include legacy components that may be incapable of accessing and interpreting available state information.

In block 302, SIM sensors may periodically scan files, folders, file systems or the like to validate integrity or to determine if any file has been compromised, attacked by a virus or other security breach. The validation may be based on a selected normative operational profile that may be established during the solution development process as described with reference to FIG. 5.

In block 304, the SIM may initiate a reaction using a SIM effector in response to a file integrity being compromised. A reaction may include creation and transmission of an alert message, marking the file unusable by changing permissions or by other means, restoring the file from a trusted repository, or other reactions to prevent the file from adversely affecting the security or integrity of the computing system.

In block 306, the SIM may publish information, create and transmit alert messages, take corrective behavior or actions or similar operations based upon events or symptoms that may occur or be detected within the computing system.

FIG. 4 is a flow chart of another example of a method 400 for maintaining a normative operational profile in a computing system in accordance with another embodiment of the present invention. The method 400 may be applicable in a SIM-enabled computing system. The methods 300 and 400 while shown and described separately, the methods may be combined to cover both legacy type computing systems and SIM-enabled systems or systems that may include both legacy components and knowledgeable components that can access and interpret state information.

In block 402, a knowledgeable component may test the integrity of a file at the time of access and initiate self-protecting behavior. Self-protecting behavior for file integrity may include three capabilities: prevention of integrity violations, remediation of integrity violations and detection of integrity violations. Examples of self-protecting behavior may include: minimizing or eliminating the potential for integrity violations, scanning the file for any viruses or other indicators that file integrity has been breached, denying access to a file based on policy, aborting access to the file, quarantining the file until any problems can be repaired, restoring the file or other actions that may render the file safe.

In block 404, a knowledgeable component may have the capability to recognize and take action for current and pending operations in response to a file being found to be corrupted, compromised or system behavior not within the normative operational profile that is in effect. Examples of actions that may be initiated by System Integrity effectors may include: not allowing certain file access operations such as read, write update, or execute; restoring a corrupted file from a trusted backup; sending an alert message to a management focal point, starting or stopping processes, starting or stopping communications methods and ports, starting or stopping devices, or similar actions.

In block 406, the SIM may publish information related to any integrity or security issues for other components of the computing system. The SIM may also create and transmit alert messages to other components of the computing system. The SIM may further take corrective behavior or actions based upon events and symptoms occurring within the computing system.

FIG. 5 is a flow chart of a method 500 for defining a normative operational profile and behavior of a computing system or environment in accordance with an embodiment of the present invention. In block 502, the normative operational behavior and profile may be established during the solution development process or process defining the purpose of the computing system and parameters related thereto.

In block 504, a set of normative operational profiles and system integrity profiles for each system architecture may be defined or established. Each normative operational profile may include a set of system integrity data that may include a registry of files and folders. Each folder may have a token that supports verification of integrity. The System Integrity Manager relies upon the accuracy and correctness of the system integrity data and the method of verifying the integrity of the file and folder information. Cryptographic algorithms and security storage mechanisms may be used by the System Integrity Manager in order to create, save and verify accuracy and correctness of files and folders. The Data Encryption Standard, or DES, and Hardware Security Modules, or HSMs, are examples of algorithms and componentry that may be employed by a SIM. These algorithms and componentry may change over time as a result of theoretical or technological advancements.

In block 506, each normative operational profile may represent a set of files and folders to accomplish the intent of the computing system. In block 508, each normative operational profile may also have the effect of excluding any files and folders that may be outside the intent of the computing system. Thus system integrity may be improved by excluding those files and folders that probably have little or no application to the purpose or business intent of the computing system.

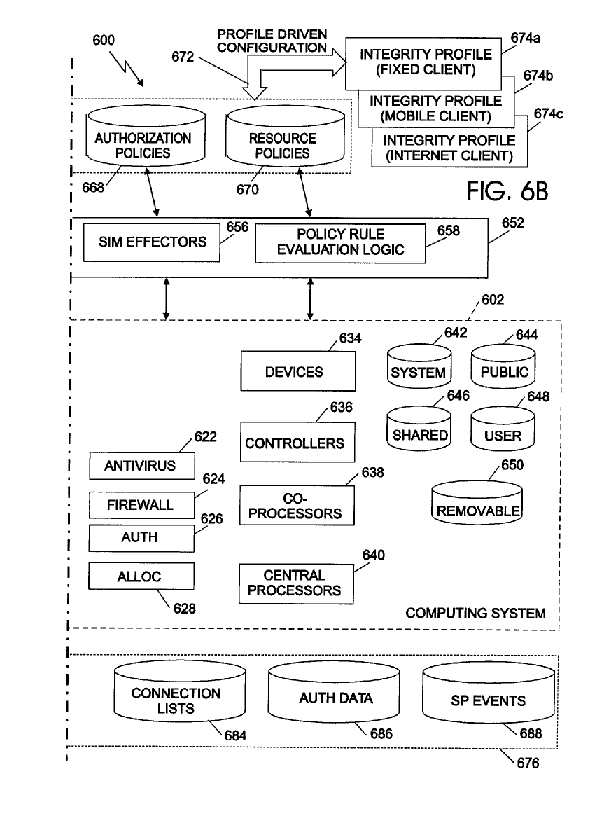

FIG. 6 is a block schematic diagram of an exemplary system 600 for providing security or integrity in accordance with an embodiment of the present invention. The methods 100-500 of FIGS. 1-5 may be performed by and embodied in the system 600. The system 600 may include a computing system 602. The computing system 602 may be an instance of a general purpose computing system. The computing system 602 may include a plurality of different components and modules that may have particular purposes or functions. Examples of the different components and modules may include client services 606, application services 608 to perform predetermined functions or operations, middleware services 610 to interface between different layers of software, management services 612, communication services 614, an operating system 618, firmware 620 and the like. Other modules or software components that may enhance system integrity and protection may include antivirus protection 622, a firewall 624, authentication provisions 626, allocation features 628 or similar security features. The computing system 602 may also include a privacy utility or module 630 to maintain system privacy and a loader utility 632 to copy programs from a storage device or the like to main memory where the program may be executed.

Examples of other system components may include devices 634, such as machine interface devices, data storage devices and the like, controllers 636 to control different system operations, co-processors 638 and central processors 640 to carry out and control the different operation of the system 602. The computing system 602 may further include a plurality of databases or data sources. Examples of the different databases or data sources may include a system database 642, a public database 644 for public data or information, a shared database 646, a user database 648 for a specific user, a removable database 650 or similar databases.

In accordance with the present invention, the system 600 for providing integrity or security may include a SIM 652. The SIM 652 may include one or more SIM sensors 654 and one or more SIM effectors 656. As previously described, the SIM 652, SIM sensors 654 and SIM effectors 656 may be used to transform an instance of a general purpose computing system, such as system 602, to a special purpose computing system 600 by performing functions and operations such as those described in methods 100-400 of FIGS. 1-4, respectively.

The SIM 652 may also include policy rule evaluation logic 658. The policy rule evaluation logic 658 may incorporate state information to invoke adaptive behavior in the computing system 602 similar to that described with respect to block 204 in method 200 (FIG. 2). Knowledgeable components of the computing system 602 may also include policy rule evaluation logic; although not shown for purposes of clarity.

The system 600 may also include a set of policies 660 that may form installation system integrity data. The policies 660 may manage asynchronous operation of the SIM 652, SIM sensors 654, SIM effectors 656 and other components of the system 600 and computing system 602 similar to that described with respect to block 110 of method 100 of FIG. 1. Examples of the different policies 660 may include content policies 662 related to data contained within files, folders, file systems and the like, execution policies 664 related to execution of executable files or programs, connection policies 666 related to connection to external resources, networks, systems, or the like, authorization policies 668 related to permissions for accessing the computing system 602 or external systems, resource policies 670 related to accessing resource, or similar policies.

The policies 660 may be profile driven as illustrated by arrow 672. As previously described with reference to FIG. 5, a normative operational behavior for a system, such as system 600 or computing system 602 may be defined by a set of normative operational profiles and a set of system integrity profiles 674. Examples of integrity profiles 674 may include a fixed client integrity profile 674a, a mobile client integrity profile 674b, an Internet client integrity profile 674c or similar integrity profiles.

The system 600 may also include variable system integrity management data 676. The variable system integrity data 676 may include rules and other data that may be accessed and used by the SIM 652 in analyzing operational data gathered by the SIM sensors 654 in invoking adaptive behavior within the computing system 602 as previously described with respect to method 100 (FIG. 1) and methods 200-400, FIGS. 2-4, respectively. Examples of the variable Si management data 676 may include privacy rules 678, file signatures 680, virus signatures 682, connection lists 684, authentication data 686, self-protect (SP) event data 688 and the like.

FIG. 7 is a block diagram of an example of a system integrity manager (SIM) 700 and a system integrity profile 702 including system integrity policies 704 to direct the SIM 700 to manage system behavior in accordance with an embodiment of the present invention. Block 706 contains examples of system behavior that the system integrity policies may direct the SIM 700 to perform. Computer-useable program code and hardware may be embodied in the SIM 700 to facilitate performance of the functions and features described in block 706 and block 708. As illustrated in block 706, the SIM 700 under direction of the system integrity policies 704 may control allocation, de-allocation and access to real and virtual resources within the controlled system; may control loading of executable modules based upon valid file fingerprints as well as appropriateness of the modules relative to the system integrity profile 702; and may control the import, export, storage and access to content. The content may include executables, data objects, multi-media and similar content. The content control may include encryption, signing, scanning, applying privacy policies or other controls. Examples of other system behaviors that may be managed by the SIM 700 under direction of the system integrity policies 704 may include controlling authorization to perform SIM functions or SIM controlled functions; controlling completion of incoming and outgoing connection requests based upon adapter, port, protocol, source, destination or other parameters; and controlling any other system behaviors that may improve system security or integrity.

As indicated in block 708, the SIM 700 may be adapted to use local system capabilities to monitor and control system behavior via sets of SIM sensors and SIM effectors as previously described. The SIM 700 may also use network communication protocols and services to interact with other SIM instances as well as operational security management systems. The SIM 700 may be further adapted to utilize available cryptographic modules, high assurance components and other security components and services or the like to maximize the integrity of the computing environment.

FIG. 8 is a block diagram of an example of an integrity subsystem 800 and exemplary functions and operations of the integrity subsystem in accordance with an embodiment of the present invention. The integrity subsystem 800 may be embodied in a SIM, such as SIM 652 of FIG. 6 or SIM 700 of FIG. 7. The integrity subsystem 800 may include a plurality of inputs, such as a requested trusted time input 802, a time-based integrity event input 804, a signaled integrity system anomaly input 806 and an integrity subsystem audit request input 808. The inputs 802, 804, 806 and 808 may be inputs to a function to manage operational integrity (OI) 810. From managing OI in block 810, the subsystem 800 may include a plurality of other functional elements. For example, an element 812 to confirm component and data integrity, an element 814 to monitor component reliability, an element 816 to verify correct operation of the computing system components, an element 818 to ensure domain separation between components, a clock 820 to maintain trusted time, and another clock 822 to provide current trusted time.

A signal 824 may be generated in response to an anomaly event being sensed by any of the elements 812, 814, 816, 818 and 820. Another signal 826 for time-based events may be generated by the trusted time clock 820 for maintaining a trusted time and allowing an integrity check to be programmed into the system to occur at predetermined time intervals. Using the trusted time avoids any change in a clock from circumventing the integrity checks.

An OI audit data element 828 may generate and record audit data related to the operational integrity function of the subsystem 800 in response to any anomalies being detected by the elements 812-822 and transmitting a signal or message to the OI audit data element 828. Another element 830 may sign and timestamp any OI audit data generated by the element 828. A data transfer element 832 may be provided to transfer any signed and time-stamped OI audit data to the manage OI element 810 to control operation of the subsystem 800 and any associated computing environment or system.

FIG. 8 illustrates a process view of a SIM-enabled computing system 800 relative to a component view of a SIM-enabled computing system as illustrated by system 600 in FIG. 6. In FIG. 8, the functional role of integrity sensors is shown by arrows terminating at block 810, and the functional role of integrity effectors is shown by arrows originating at block 810. In addition, the actions of system integrity effectors will be known to SIM via block 832. This “feedback” path represents a “closed loop” necessary for adaptive integrity management.

Other subsystems for forming a secure system solution are described in pending U.S. patent application Ser. No. 09/838,749 entitled “Method and System for Architecting a Secure Solution by Gilbert et al., filed Oct. 24, 2002 and assigned to the same assignee as the present application and incorporated herein by reference in its entirety.

From the foregoing, the SIM of the present invention thus permits a general purpose computing system to be transformed to a special purpose computing system and saves the time and expense associated with custom building or hardening a computing system. The present invention may also provide more accurate enforcement of the business intent or purpose of the computing system or environment as defined by a system designer. The range of security vulnerabilities that may be exploited by threats or threat agents may also be reduced by controlling and adapting the normative system behavior as previously described. Operational security is improved by preventing certain classes of attacks, thereby reducing the amount of uncorrelated security event information flowing on a network. Additionally, the SIM of the present invention may provide more accurate and detailed security information to a Network Operations Center (NOC), Security Event Management software or the like for managing overall system security and integrity.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for providing security, comprising transforming an operational behavior of an instance of a computing system from a general purpose computing system to a special purpose computing system, wherein the operational behavior is transformed by using at least one of a system integrity sensor, a system integrity effector, a set of system integrity policies, and system integrity data.

2. The method of claim 1, further comprising
gathering operational data related to operating conditions and operations within the computing system;
analyzing the operational data to form state information; and
invoking adaptive behavior in at least one component of the computing system if needed based on the state information.

3. The method of claim 2, wherein invoking adaptive behavior comprises at least one of:
changing policy information for the at least one component based upon an evaluation of the set of system integrity policies within a given operational state;
incorporating the state information in a policy rule evaluation logic of at least one of a security integrity manager associated with the computing system and the at least one component;
authorizing an external security integrity manager external to the computing system to alter operation of the security integrity manager associated with the computing system; and
resetting the state information.

4. The method of claim 1, further comprising initiating control operations capable of invoking change in any legacy components which are incapable of accessing and interpreting available state information.

5. The method of claim 1, further comprising managing operation of a system integrity manager, a plurality of system integrity sensors, a plurality of system integrity effectors and a plurality of other components based on a set of policy rules.

6. The method of claim 1, further comprising maintaining a normative operational profile of the computing system.

7. The method of claim 6, wherein maintaining the normative operational profile of the computing system comprises:
periodically scanning each file, folder and file system associated with the computing system to validate integrity based on the normative profile; and
initiating a reaction in response to integrity being compromised.

8. The method of claim 7, wherein initiating a reaction comprises at least one of:
creating and transmitting an alert message;
marking an integrity compromised file unusable;
changing permissions for using the integrity compromised file;
restoring the integrity compromised file from a trusted repository; and
correcting behavior based upon any events or symptoms.

9. The method of claim 6, wherein maintaining the normative operational profile of the computing system comprises:
testing the integrity of a file when being accessed; and
initiating a self-protection behavior in response to the file being found to be compromised.

10. The method of claim 9, further comprising:
notifying a system integrity manager in response to the file being found to be compromised; and
correcting behavior based upon any events and symptoms.

11. A system for providing security, comprising:
a system integrity manager for transforming an operational behavior of an instance of a computing system from a general purpose computing system to a special purpose environment; and
at least one system integrity sensor to gather operational data related to operating conditions and operations within the computing system.

12. The system of claim 11, further comprising at least one system integrity effector to initiate control operations to invoke change in any legacy components in the computing system.

13. The system of claim 11, wherein the system integrity manager analyzes the operational data, to form state information and to invoke adaptive behavior in each component of the computing system as needed based on the state information.

14. The system of claim 13, wherein the system integrity manager invokes adaptive behavior by at least one of a group comprising:
changing policy information for the at least one component based upon an evaluation of the set of system integrity policies within a given operational state;
incorporating the state information in a policy rule evaluation logic of at least one of a security integrity manager associated with the computing system and the at least one component;
authorizing an external security integrity manager external to the computing system to alter operation of the security integrity manager associated with the computing system; and
resetting the state information.

15. The system of claim 11, further comprising a set of policy rules to manage operation of the system integrity manager.

16. The system of claim 11, further comprising a normative profile selected for operation of the computing system, wherein the at least one system integrity sensor periodically scans each file, folder and file system associated with the computing system to validate integrity based on the selected normative profile.

17. The system of claim 16, wherein the system integrity manager initiates a reaction in response to integrity being compromised.

18. The system of claim 11, further comprising:
system integrity installation data accessible by the system integrity manager; and
system integrity management data accessible by the system integrity manager for maintaining a normative operational profile of the computing system.

19. A computer program product for providing security, the computer program product comprising:
a computer useable medium having computer useable program code embodied therein, the computer useable medium comprising:
computer useable program code configured to transform an operational behavior of an instance of a computing system from a general purpose computing system to a special purpose computing system.

20. The computer program product of claim 19, further comprising:
computer useable program code configured to gather operational data related to operating conditions and operations within the computing system;
computer useable program code configured to analyze the operational data to form state information; and
computer useable program code configured to invoke adaptive behavior in at least one component of the computing system if needed based on the state information.

21. The computer program product of claim 19, further comprising computer useable program code configured to initiate control operations capable of invoking change in any legacy components which are incapable of accessing and interpreting available state information.

22. The computer program product of claim 19, further comprising computer useable program code configured to maintain a normative operational profile of the computing system.

23. The computer program product of claim 22, further comprising
computer useable program code configured to periodically scan each file, folder and file system associated with the computing system to validate integrity based on the normative profile; and
computer useable program code configured to initiate a reaction in response to integrity being compromised.

24. The computer program product of claim 23, wherein the computer useable program code configured to initiate a reaction comprises at least one of:
computer useable program code configured to create and transmit an alert message;
computer useable program code configured to mark an integrity compromised file unusable;
computer useable program code configured to change permissions for using the integrity compromised file;
computer useable program code configured to restore the integrity compromised file from a trusted repository; and
computer useable program code configured to correct behavior based upon any events or symptoms.

25. The computer program product of claim 22, further comprising
computer useable program code configured to test the integrity of a file when being accessed; and
computer useable program code configured to initiate a self-protection behavior in response to the file being found to be compromised.
